(19) United States
(12) Patent Application Publication
(10) Pub. No.: US 2010/0169784 A1
(43) Pub. Date: Jul. 1, 2010

(54) Slide Show Effects Style

(75) Inventors: Ralf WEBER, Cupertino, CA (US); Adrian Diaconu, Cupertino, CA (US); Guillaume Vergnaud, Tokyo (JP); Bob Van Osten, Cupertino, CA (US)

Correspondence Address: Morgan Lewis & Bockius LLP/ AI, 2 Palo Alto Square, 3000 El Camino Real, Suite 700, Palo Alto, CA, 94306, US

(73) Assignee: Apple Inc., Cupertino, CA (US)

(21) Appl. No.: 12/499,794

(22) Filed: Jul. 8, 2009

Related U.S. Application Data
(60) Provisional application No. 61/193,849, filed on Dec. 30, 2008.

(51) Int. Cl. G06F 3/00

(52) U.S. Cl. 715/731

(57) ABSTRACT

A computer-implemented method for authoring media presentations is provided. The method includes steps for defining a style. The style comprises one or more style properties. The style is applied to a layer. The layer comprises one or more effects. The style may also be applied to a document, effect container, effect, or slide. A media presentation is automatically generated using the applied style and the layer. A media presentation is also automatically generated using the applied style and the document and at least one of the layer, the effect container, the effect, and the slide.

This application claims the benefit and priority of the U.S. Provisional Patent Application No. 61/193,849 filed on Dec. 30, 2008, which is hereby incorporated by reference.

### FIELD OF INVENTION

The present invention relates generally to the field of media presentations and, in particular, to authoring media presentations using styles.

### BACKGROUND OF INVENTION

Current media presentation applications offer features for creating slides and manually customizing the ways in which a set of slides, i.e., a slideshow, is played. Such applications also offer features for attaching themes to slideshows, where such themes may affect the appearance and general behavior of the slideshows when played. In addition, such applications further offer features such as customizing slide colors, customizing transition behavior, customizing transition delay, and manually adding clip art/image/audio/video files to one or more slides in a slideshow. These applications also permit basic sequential transition, forward or backward, from one slide to another in a slideshow containing more than one slide. A user may customize the time that one slide should be viewed prior to the application invoking a transition to another slide, which may further have a custom viewing time associated with it, as well.

However, current media presentation applications do not define a style, the style comprising one or more style properties, apply the style to a layer, the layer comprising one or more effects, and automatically generate a media presentation using the applied style and the layer.

Furthermore, current media presentation applications do not dynamically profile audio data, such as a slideshow soundtrack, based on various audio parameters, including beats per minute, rhythmic strength, harmonic complexity, and/or square root of the arithmetic mean of the square of density variations (RMS) strength. In addition, current media presentation applications do not utilize the profiled audio data to select appropriate effects, transitions, or filters and assemble them in useful ways to author a media presentation. Current media presentation applications also do not set effect durations, in/out points, and transitions in-sync with audio alone or the audio of a video.

Moreover, current media presentations applications do not author media presentations by defining a layer, where the layer comprises one or more effects, associating media content with the layer, aggregating the layer with one or more other layers, and assembling the aggregated layers.

Finally, current media presentation applications do not provide automatic, as well as user-defined, authoring, rendering, exporting, and sharing media presentations/slideshows in an easily integrated platform.

### SUMMARY OF THE INVENTION

Accordingly, the present invention is directed to a system and method for authoring slideshows using styles that substantially obviates one or more problems due to limitations and disadvantages of the related art.

An embodiment of the present invention provides a computer-implemented method for defining a style, the style comprising one or more style properties, applying the style to a layer, the layer comprising one or more effects, and automatically generating a media presentation using the applied style and the layer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system comprises memory to store a style, the style comprising one or more style properties, and one or more processors configured to define the style, apply the style to a layer, and automatically generate a media presentation using the applied style and the layer, the layer comprising one or more effects.

In another aspect, a computer-readable storage medium stores one or more programs configured for execution by a computer, the one or more programs comprising instructions to define a style, the style comprising one or more style properties, apply the style to a layer, the layer comprising one or more effects, and automatically generate a media presentation using the applied style and the layer.

In another aspect, a computer-implemented method comprises defining a style, the style comprising one or more style properties, applying the style to a document and at least one of a layer, an effect container, an effect and a slide, and automatically generating a media presentation using the applied style, the document, and the at least one layer, effect container, effect, and slide.

In another aspect, a system comprises memory to store a style, the style comprising one or more style properties, and one or more processors configured to define the style, apply the style to a document and at least one of a layer, an effect container, an effect and a slide, and automatically generating a media presentation using the applied style, the document, and the at least one layer, effect container, effect, and slide.

In yet another aspect, a computer-readable storage medium stores one or more programs configured for execution by a computer, the one or more programs comprising instructions to define a style, the style comprising one or more style properties, apply the style to a document and at least one of a layer, an effect container, an effect and a slide, and automatically generate a media presentation using the applied style, the document, and the at least one layer, effect container, effect, and slide.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 illustrates an exemplary embodiment of an application in accordance with the present invention;

FIG. 2 illustrates features of an exemplary embodiment in accordance with the present invention;

FIG. 2A illustrates features of an exemplary embodiment in accordance with the present invention;

FIG. 3 is a block diagram illustrating framework features of an exemplary embodiment in accordance with the present invention;

FIG. 3A is a block diagram illustrating framework features of an exemplary embodiment in accordance with the present invention;

FIG. 4 illustrates an exemplary system implementing an application in accordance with the present invention;

FIG. 5 illustrates an exemplary implementation of an application in accordance with the present invention;

FIG. 6 illustrates an exemplary method in accordance with the present invention;

FIG. 7 illustrates an exemplary method in accordance with the present invention;

FIG. 8 illustrates an exemplary method in accordance with the present invention;

FIGS. 9A-9B illustrate exemplary style properties in accordance with the present invention;

FIGS. 10A-10U illustrate exemplary style properties in accordance with the present invention;

FIGS. 11A-11B illustrate exemplary style properties in accordance with the present invention; and

FIG. 12 illustrates an exemplary method in accordance with the present invention.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of standalone system or client-server compatible system containing any type of client, network, server, and database elements.

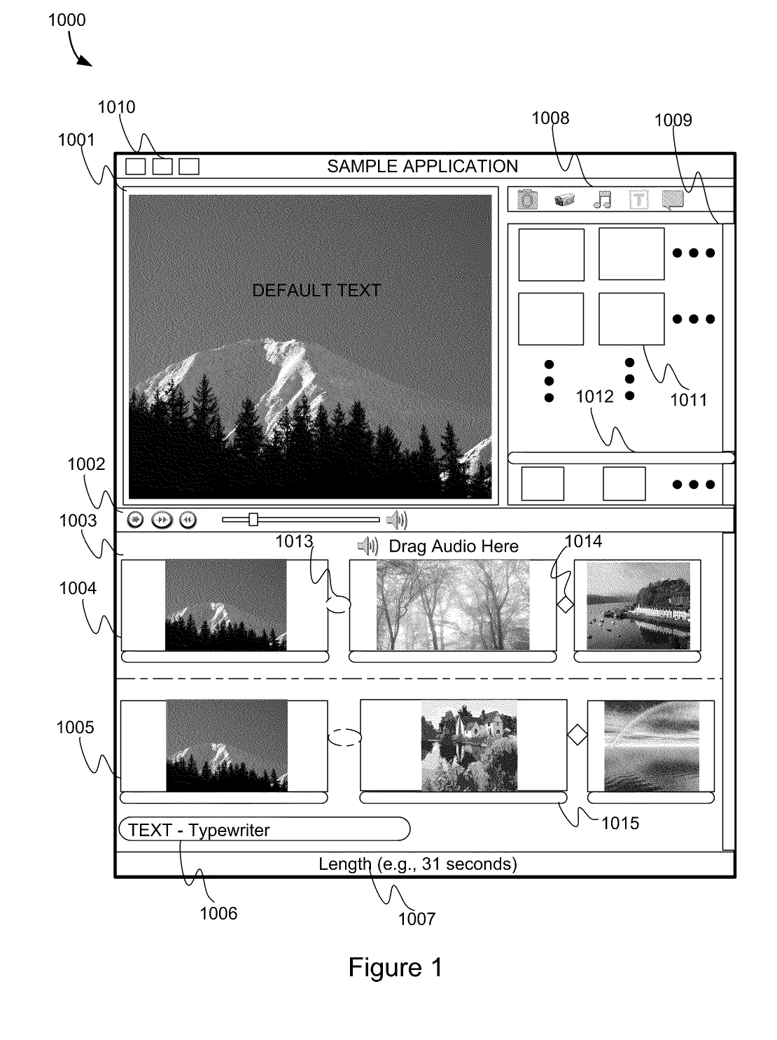

FIG. 1 illustrates an exemplary embodiment of an application in accordance with the present invention. The exemplary embodiment of an application 1000 comprises a document 1001, a set of controls 1002 for controlling/manipulating the document 1001, an edit layers and effect containers region 1003 (e.g., steps 6001, 7001), a background layer 1004 with effect containers and effects associated with the effect containers, a foreground layer 1005 with effect containers and effects associated with the effect containers, a text typewriter 1006 for associating text with one or more effect containers/effects/slides, a document length 1007 indicator, a select media content menu 1008 (e.g., steps 6002, 7002), a main effects library 1009, a documents selection menu 1010 for selecting among available documents, one or more effects 1011 (which may be available according to a filter criteria) within the main effects library 1009, a subset of the main effects library 1012, a gap variable 1013 for separating an effect or effect container (with one or more effects and slides) from the next effect or effect container using a gap, a transition variable 1014 for separating an effect or effect container (with one or more effects and slides) from the next effect or effect container using a transition, and an effect style 1015 (also, name or property). The exemplary embodiment of an application 1000 illustrates a use of the application 1000 to create a document 1001 (e.g., steps 6004, 7004) using a background layer 1004, a foreground layer 1005 (additional background/foreground layers may also be added to the document but may not be illustrated in FIG. 1) (e.g., steps 7008, 7009), customized gaps 1013 and/or transitions 1014 separating effect containers. Effect containers may comprise, for example, one or more effects from, for example, the main effects library 1009 or the subset of the main effects library 1012; and, effects may further comprise one or more slides like, for example, images, movies, audio, text (e.g., a string with font information that may determine how text will look and feel), and other media content (e.g., steps 6002, 7002, 7006, 7012, 7013). Effects may determine how the image and its surroundings will appear on a screen/display during play (e.g., an image may be displayed according to “book theme,” where the effect would be the feature/component for determining how the photos may be laid out or organized on-screen; an effect may store/pass information related to how a photo would bounce around on a screen; or, an effect may also store/pass information related to text, where the text may be added or associated with a slide, effect, layer, or document of a slideshow/media presentation). Further, effects may be filtered according to media content type using the select media content menu 1008. For example, images, video, audio, text, and captions may be used to filter effects accordingly. Meaning, the relevant effects associated with each of the foregoing types of media content may be displayed accordingly upon invocation of the respective menu item from the select media content menu 1008. Details regarding effects may be displayed in the effects style 1015 section, which may be positioned beneath each respective effect container, and corresponding to a presently active effect, in the effect containers region 1003.

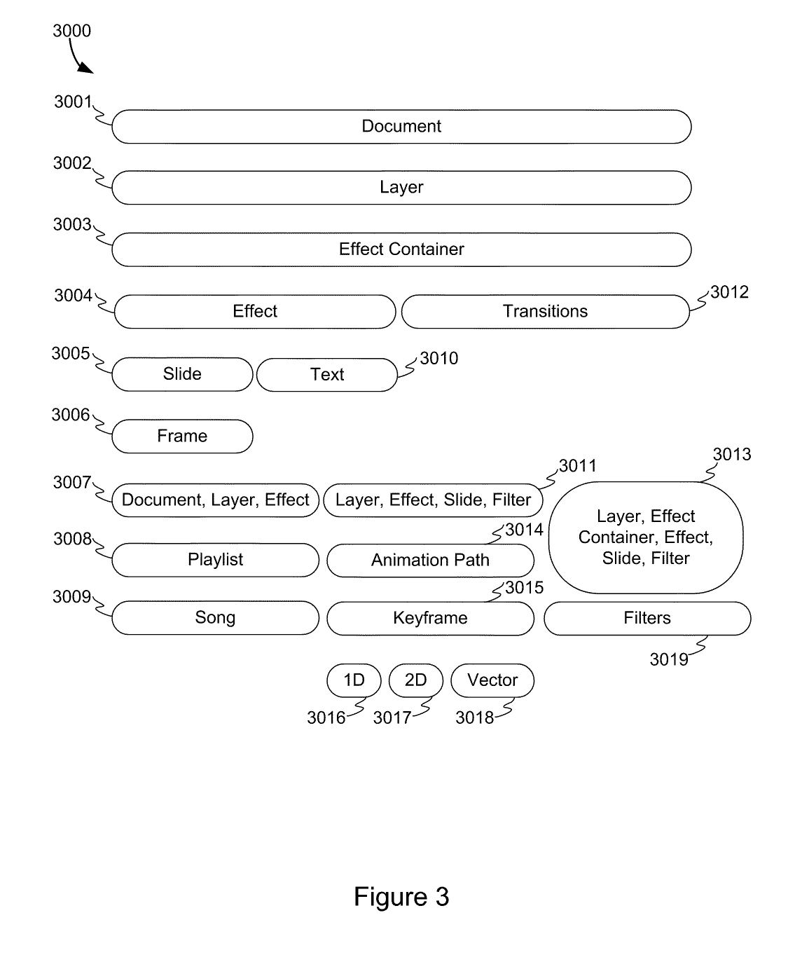

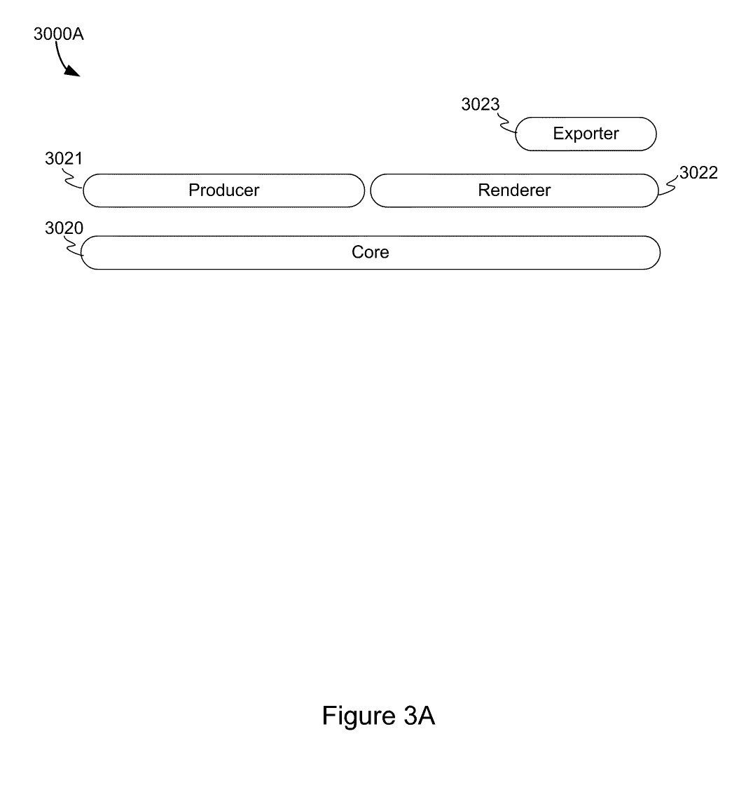

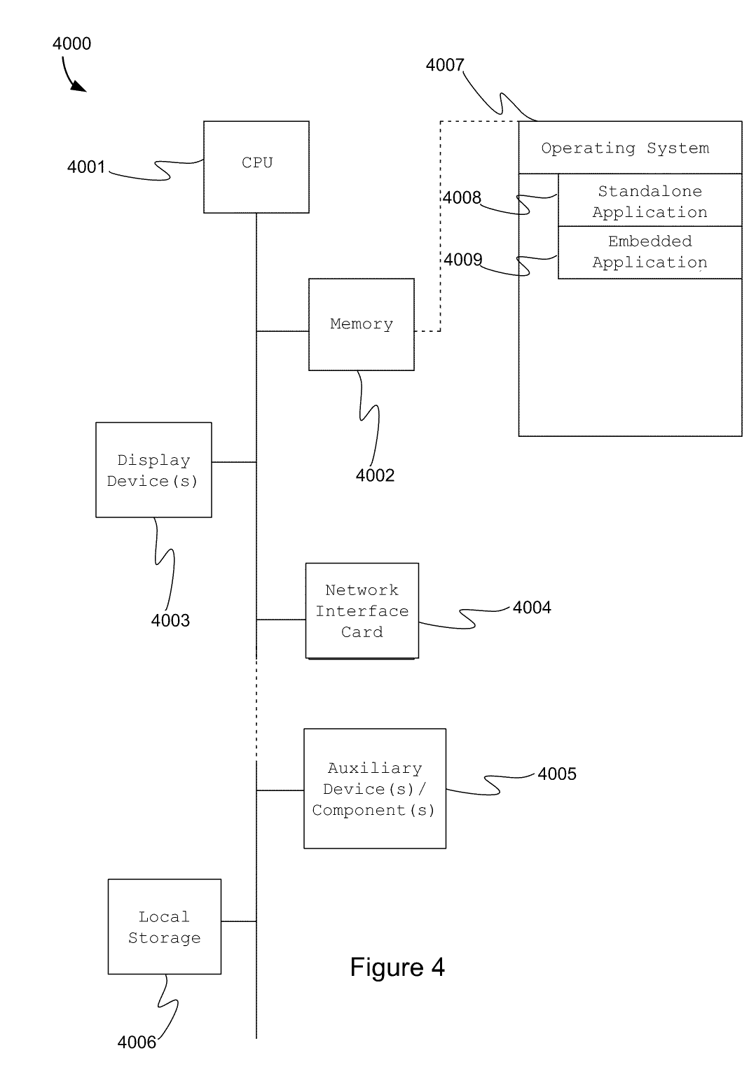

In some embodiments, the exemplary embodiment of an application 1000, and its features/components, may be implemented by one or more modules/engines (FIG. 3A, reference numerals 3020-23) executed using an exemplary system 4000 (FIG. 4) with a central processing unit (CPU) 4001 (and, alternatively, multiple CPUs), memory 4002 for storing data (e.g., instructions from an operating system 4007 or one or more programs (e.g., 4008, 4009)) to be fetched by the CPU for execution, a display device 4003 for displaying the exemplary application 1000 using a graphics module to a display screen, a network interface card (NIC) 4004 for sending and receiving data over a wired or wireless communications network, local storage 4006 for storing media content and other data (e.g., an operating system 4007, the exemplary embodiment of an application 1000, other applications, etc.), and auxiliary device(s)/component(s) 4005 (e.g., TV (or, other display), portable storage, portable media player, etc.), which may all be connected via a bus for sending and receiving data according to a frequency (e.g., synchronous or asynchronous).

In some embodiments, the features/components of the application 1000 may be described as follows. The document 1001 (also, FIG. 3, reference numeral 3001) is the top level object of the media presentation/slideshow that may be created (e.g., steps 6004, 7004) using the exemplary application 1000. The document is the object that may comprise: all of the custom/default layers 1004, 1005 (also, FIG. 3, reference numeral 3002) (e.g., steps 6003, 7003, 7010), effect containers such as, for example, those within the effect containers region 1003 (also, FIG. 3, reference numeral 3003); effects such as, for example, those within the effect containers (also, FIG. 3, reference numeral 3004); gaps 1013 or transitions 1014 for separating or linking effects, respectively (also, FIG. 3, reference numeral 3012); slides such as, for example, the images of FIG. 1 or other media content as described above (also, FIG. 3, reference numeral 3005, 3010) (e.g., step 6002, 7002); frames 3006; a document/layer/effect stack 3007; a layer/effect/slide/filter stack 3011; a playlist 3008; an animation path 3014; a song 3009; a keyframe 3015 (which may, for example, be one dimensional (1D) 3016, two dimensional (2D) 3017 or a vector (3018)); filters 3019; a layer/effect container/effect/slide/filter stack 3013; and, any other possible combination of the aforementioned. Moreover, a document may contain layers that may be stacked/placed one on top of another to provide the media presentation/slideshow with an added level of flexibility in what is available for actual display (e.g., steps 6003, 7003, 7010). Accordingly, the application supports the presentation of less than all of the available layers. Stacking may involve a process, for example, of logically associating, or linking, layers. That is, a background layer 1004 may be considered the lowest level layer in a stack of layer, followed by a foreground layer 1005 and a plurality of other foreground layers, all of which would be logically associated according to their position from, for example, background layer 1004, or from each other foreground layer. During display/play of a document such as, for example, document 1001, the layers would be displayed/played according to their respective positions in the stack (logical associations). The next feature/component is the layers 1004 (background), 1005 (foreground) (also, FIG. 3, reference numeral 3002) within a document 1001 (also, FIG. 3, reference numeral 3001) (e.g., steps 6001, 7001). Each layer 1004, 1005 of a stack of layers (e.g., aggregated layers; steps 6003, 7003) within a document can be positioned, sized, and rotated using the exemplary application 1000. Further, each layer 1004, 1005 may also have a custom audio file/track (or, alternatively, a set of audio files/tracks, or other media content) associated with it and other layers 1004, 1005, thus, providing a media presentation/slideshow with multiple audio files/tracks during presentation (e.g., steps 6002, 7002). Each layer 1004, 1005 may also contain effect containers (like, for example, those illustrated in the effect containers region 1003) (e.g., steps 6002, 7002), which may be linked together in a layer using transitions 1014 (also, FIG. 3, reference numeral 3012) or separated from one another using gaps 1013 (or, alternatively, some other effect separation variable like, for example, random separation/transition, or a combination of gaps and transitions, etc.) (e.g., 7005). Transitions 1014, which through visual action/expression may create the appearance that two effect containers are linked together, may be able to provide a rather “fluid” (or, alternatively, a “non-fluid”) experience between effect containers when presenting a media presentation/slideshow. For example, transitions may be the visual action/expression of a page flipping, a slide dissolving, a slide being pushed along in any direction, a cube breaking apart (or, being assembled), a page rolling for the purpose of unveiling/hiding contents, a puzzle being assembled (or, disassembled), or any other type of visual action/expression applied to an effect container or slide and capable of being rendered on a display device. Slides in the exemplary application may be the actual image, movie, text, or other media content that may be within an effect, which may be within an effect container (e.g., steps 6002, 7002). Slides may have frames applied as an added layer (e.g., on top), where a frame may be a visual element/expression such as, for example, making an image appear as if it was taken using an instant photo camera (e.g., Polaroid®), is part of a filmstrip, has a solid/dashed/shadowed/other border surrounding it, or other type of frame-related visual element/expression. Further, each slide may have an animation path 3014 that may determine which part of a slide image, movie, text, or other media content, is actually displayed/played; similarly, an animation path 3014 associated with the slide may cause a panning/zooming effect to be executed on the image, movie, text, or other media content, where the panning/zooming may occur within the effect of the slide. As applied to a layer, a user may also customize an animation path 3014 via the exemplary application 1000 to, for example, smoothly transition a layer's rotation from around zero (0) degrees all the way to three hundred sixty (360) degrees, over a default or custom period of time (e.g., steps 6002, 7002). In some embodiments, transitions 1014 may have durations associated with them to determine how long the transitions are played. The transition duration may be subtracted directly from the total duration of the effect containers separated/divided by the transition. For example, when transitioning from an effect container with a three (3) second duration to another effect container with a three (3) second duration, that is, having a six (6) second total duration, using a transition with a one (1) second duration, the effect containers may only be played for a total of five (5) seconds (i.e., the total six (6) second duration of the effect containers minus the one (1) second transition display/play duration leaves five (5) seconds of display/play duration for the effect containers).

In some embodiments, effect containers may be able to determine the order that images (or, alternatively, other media content) associated with a layer (e.g., steps 6002, 7002) are presented during a media presentation/slideshow. Such a determination may be based according to characteristics associated with the images (or, alternatively, other media content) (e.g., steps 6004, 7004). The characteristics may comprise a resolution, size, quality indicator, dots-per-inch, frames per second, window size, bit error rate (BER), compression type, or some other media content characteristic. The exemplary application 1000 may execute this process of assembling the layers (e.g., steps 6004, 7004) either manually or according to algorithms processing the characteristics and other layer-related data (described above). Further with respect to effect containers (e.g., a container or group of effects), multiple effects may be transitioned as one set into the next effect container. For example, effect containers are necessary in order for different text to be displayed on top of different effects. In some embodiments, from an implementation viewpoint, the effect containers permit the logical/physical grouping of different effects and link each of the effects to their respective different text, which is to be displayed on top of each respective effect. Each effect container may, for example, further contain a variable for storing a specific duration for determining how long each of the effects associated with an effect container (or, alternatively, “within” the effect container) are displayed/played.

In some embodiments, a keyframe 3015 (which may, for example, be one dimensional (1D) 3016, two dimensional (2D) 3017 or a vector (3018)), may be used by an animation path 3014 to guide or instruct the rate at which animation path 3014 should operate. Meaning, the higher the value of a keyframe 3015, the increased rate the animation path 3014 may operate (e.g., a faster pan-zoom effect or a faster layer rotation), and the lower the value of a keyframe 3015, the lower rate the animation path 3014 may operate at (e.g., a slower pan-zoom effect or a slower layer rotation). A 1D 3016 keyframe may be a keyframe that animates a property that has one value like, for example, a rotation angle. A 2D 3017 keyframe may be a keyframe that animates a property that has more than one value like, for example, a position (x-axis point, y-axis point) or a size (width/length, height). And, a vector 3018 keyframe may be a keyframe that animates a property that has more than two values like, for example, colors that manipulate the different values of their constituent color components (e.g., red, green, blue, alpha).

In some embodiments, filters 3019 operate as visual elements that are applied to a layer, effect container, effect, or slide. A filter 3019 may be, for example, a shadow, blurred image, or some other compatible visual element capable of being applied to a layer, effect container, effect, or slide (e.g., steps 6002, 7002).

In some embodiments, a playlist 3008 associated with a document 1001 may contain a list of songs (e.g., steps 6002, 7002). The playlist 3008 may organize songs such that they are played in a specific order, determined manually by a user of the exemplary application 1000, or automatically through the exemplary application 1000. An automatic playlist may be created according to song genre, file characteristics (e.g., type, size, date, etc.), or according to the feature for dynamically profiling a slideshow soundtrack based on various criteria like beats per minute (BPM), rhythmic strength (RS), harmonic complexity (HC), and/or root mean square density (RMS or RMS strength). The songs (e.g., a reference to a playlist) may be stored in digital format in local storage 4006 or on an auxiliary device/component 4005 that communicates with the system 4000 through a communications protocol or standard. The songs may be stored in a single file (or, other logical/physical data aggregator) or many files. In addition to songs, a playlist 3008 may contain other compatible media content like videos with audio content (which, for example, may be parsed from the video file into an individual song/audio file, or playlist). To associate a playlist, song/audio file, or any compatible media content with a document 1001, the user may select it/them from the select media content 1008 menu and drag the respective playlist, song/audio file, or other compatible media content, via the exemplary application 1000, into the effect containers region 1003 (see, for example, the reference to “Drag Audio Here” in the exemplary application 1000) (e.g., steps 6002, 7002). Songs may be played in the background while a document is being displayed/played, or they may, alternatively, be associated with foreground layers or effects that may be organized on top of another, thus, enabling the songs to be switched in coordination with the various switching (e.g., via gaps or transitions) from one layer or effect to another (e.g., steps 6004, 7004). Further, songs may, according to a default setting, start and stop playing based on the start and stop times that may be given from a media player or media management application. The user of the exemplary application 1000 may, however, define a custom start or stop time via a song (or, playlist) menu option of the application 1000.

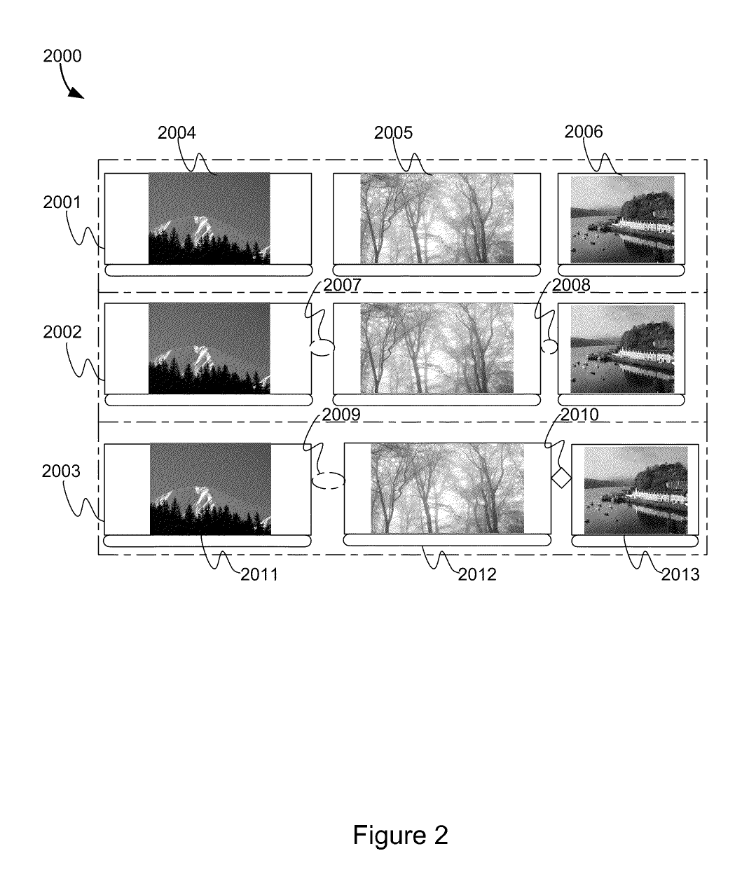

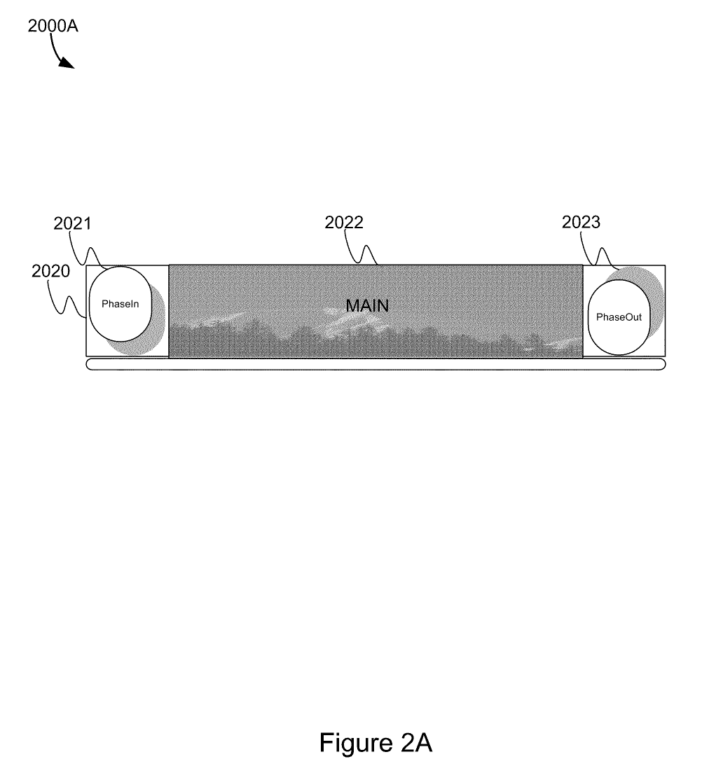

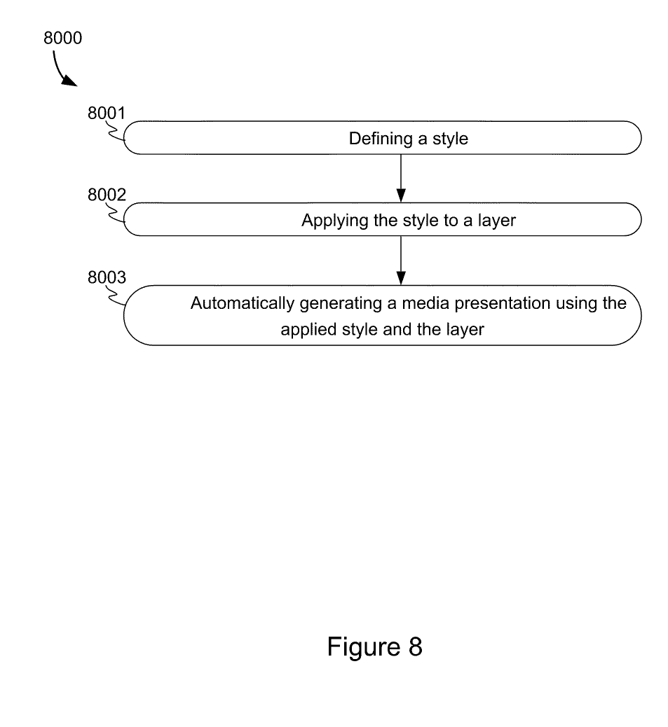

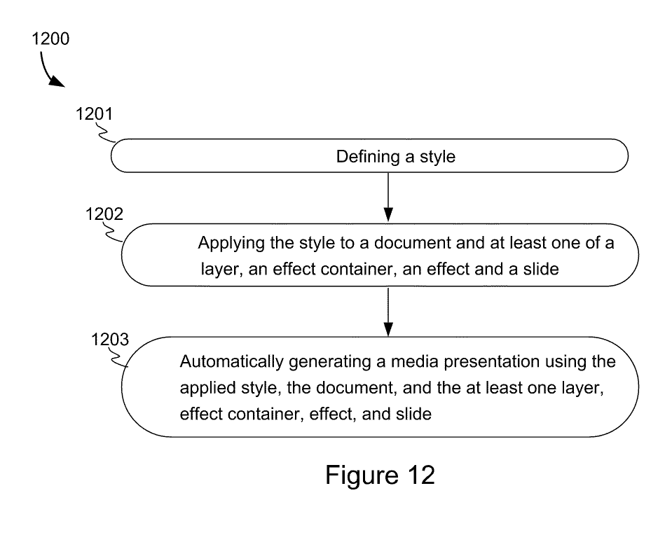

FIG. 2 illustrates features of an exemplary embodiment in accordance with the present invention. As illustrated, the exemplary embodiment of an add effects container region 2000 (similar to that of 1003; FIG. 1) contains three layers, the first is a background layer 2001, and the second and third are foreground layers 2002 and 2003 (e.g., steps 6001, 7001, 6002, 7002, 7008, 7009). Effect containers are illustrated as 2004, 2005, and 2006 in the background layer 2001. The foreground layers 2002 and 2003 also contain effect containers. Each effect container has effects with slides/media content within, such as illustrated by the slides (e.g., images) 2011 and 2013 in the second foreground layer 2003. Moreover, gaps 2007, 2008, 2009 separate effect containers in foreground layers 2002 and 2003. Also, transition 2010 separates (or, “link”) effect containers in the foreground layer 2003. Further, an effects style 2012 is illustrated for the second effect container of the second foreground layer 2003 (e.g., step 7007). The effects style may display one or more styles or properties such as, for example, a media presentation order, a thumbnail, a layout, a position, a size, a z-position(e.g., the position in a three-dimensional (x, y, z) orientation), a base period, an effect presets, an effect settings overwrite, a matching layer duration, a recommended effect duration, a transition preset, a transition settings overwrite, a recommended transition duration, a filter preset, a filter preset criteria, a filter likelihood, a gap likelihood, a layer importance, a slide filter preset criteria, a slide frames criteria, an automatic filter likelihood, and a support per-slide customization (e.g., step 7014). The styles and properties will be described in further detail below with respect to the methods in FIG. 8 and FIG. 12. Other styles or properties may also be displayed at 2012 or in another section of the graphical user interface of the exemplary application 1000 or at the container region 2000 like, for example, a background color and an automatic filter mode (e.g., step 7015). The styles or properties may apply to the slides, effects, effect containers, layers, and/or document, and may further be customized for each of the foregoing or inherited from each other, whether set by default or is customized (e.g., step 7007).

FIG. 2A illustrates features of an exemplary embodiment in accordance with the present invention. The exemplary embodiment 2000A illustrates an effect container 2020 with a phaseIn effect 2021, a main effect 2022, and a phaseOut effect 2023. Also, the blurred image (or, movie or other media content) shown behind the “main” text illustrates an exemplary instance of a blurred effect during the main effect 2022 phase of the effect container 2020. The phaseIn effect 2021 (e.g., like a fade-in) may be used, for example, to build a single/multi-slide layout, where as the phaseOut effect 2023 (e.g., like a fade-out) may be used, for example, to tear down/away or remove a single/multi-slide layout. Thus, the phaseIn 2021, main 2022, and phaseOut 2023 effects may be applied to a single slide or to multiple slides. Furthermore, there may be a time associated with each phaseIn effect 2021, main effect 20222, and phaseOut effect 2023. The time spent on each slide of a multi-slide effect may be equally divided among the individual slides (e.g., total effect time divided by the total number of slide, and adjusted accordingly) or apportioned in a custom manner to each individual slide.

FIG. 3 is a block diagram illustrating framework features of an exemplary embodiment in accordance with the present invention. In some embodiments, the exemplary application 1000 executing on the exemplary system 4000 may cause the CPU 4001 to execute instructions for creating an electronic structure (e.g., 3000) for storage in memory 4002, local storage 4006, or on an auxiliary device/component 4005, such instructions may comprise: creating a document (e.g., 3001); associating one or more layers (e.g., 3002) to the document, wherein the layers (e.g., 3002) are organized within the document (e.g., 3002); associating one or more effect containers (e.g., 3003) with the layers, wherein the effect containers (e.g., 3003) are linked and are organized within the layers (e.g., 3003); associating one or more effects (e.g., 3004) with the effect containers (e.g., 3004); and assembling the effects (e.g., 3004), effect containers (e.g., 3003), and layers (e.g., 3002) logically within the document. The application features 3000-3019 are referred to and described in detail herein, and in view of the exemplary application 1000, which may be executed, for example, on the exemplary system 4000.

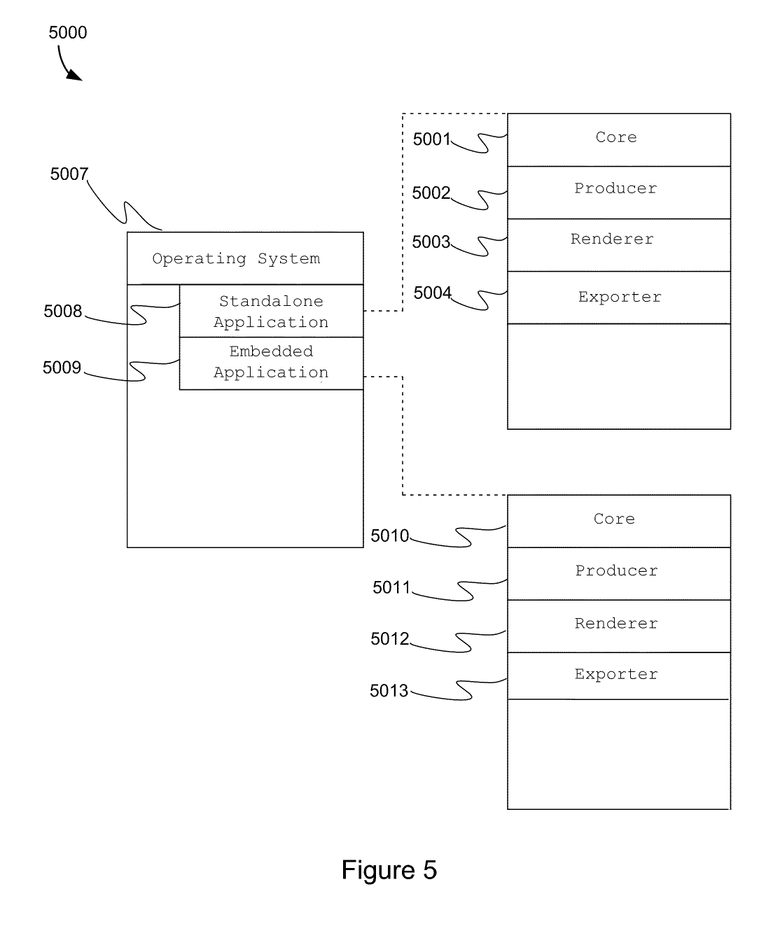

FIG. 3A is a block diagram illustrating framework features of an exemplary embodiment in accordance with the present invention. The framework features 3000A may comprise framework module units (or, modules) such as, for example, a core 3020, a producer 3021, a renderer 3022, and an exporter 3023. The features 3000A may implement the structure/architecture of the exemplary application 1000, and may be executed, for example, using a system like that illustrated in FIGS. 4-5.

In some embodiments, the core 3020 module may be considered the low-level data structure module and it may, for example, perform routines for representing how a slideshow/media presentation document is constructed, and contain the necessary information for accurately representing a slideshow/media presentation document according to features, many of which are described herein (e.g., steps 6001-6003, 7001-7003). Some of those features may include, for example, features related to timing (e.g., gaps 1013, transitions 1014), positioning (e.g., background layer 1004, foreground layer 1005, effects of effect containers 2004-2006, slides 2011, filters 3019, text 3010), sizing (e.g., keyframe 3015, animation path 3014, as well as their interaction), and files (e.g., songs 3008, playlists 3009).

In some embodiments, the producer 3021 may be considered the module for creating how a slideshow will look and feel (e.g., steps 6002-6003, 7002-7003), performing several analyses related to media content (e.g., images, audio, video of layers, effect containers, effects, and slides) (e.g., step 7016), and automatically assembling slideshows/media presentations according to data that may result from the analyses (e.g., steps 6004, 7004, 7011). The several analyses (e.g., step 7016) may include analysis of characteristics related to layers, effect container, effects, and slides. Such characteristics may include, for example, layer type (e.g., background 1004, foreground 1005), layer number (e.g., position in relation to the background-most layer 1004), number of effect containers, length of gaps 1013 and transitions 1014, type of transitions 1014, type of effects, number of effects, number of slides, type of slides, document length 1004, user preferences (e.g., for ordering layers, effect containers, effects, slides), audio analyses, video analyses, or other similar characteristics. After performing the several analyses using, for example, the producer 3021, the resulting data from the several analyses may be processed by the producer 3021, the core 3020, the renderer 3022, the exporter 3023, or other module (e.g., step 7017). The producer 3021 may, for example, interface with and utilize the application programming interfaces (API) of frameworks like, for example, browsers or QuickTime® to gather such information as thumbnail data and resolutions for images, as well as audio or video durations or other characteristics. The gathered information may then be processed by the producer 3021 in accordance with one or more general/specific algorithms (or, other analytical methods) and then used by the producer 3021 (or, other module with which the producer 3021 may call), for example, to automatically assemble a slideshow or media presentation document (e.g., 7011). The producer 3021 may further, for example, assemble a document via core 3020 for play/display using the features of renderer 3022, by accessing photos and coupling such photos with a style (e.g., 1015). In addition, the producer 3021 may also, for example, perform audio analysis functions on songs 3009 or a set of songs (playlist 3008) using such analysis like, for example, beat detection/mapping. The producer 3021 may also keep track of available styles (e.g., 1015), effects 3004, transitions 3012, and frames 3006.

In some embodiments, the renderer 3022 may be considered the play/display module. The renderer 3022 may receive slideshow/media presentation data from, for example, the core 3020 and producer 3021 and may render such data such that it may be sent to a graphics card or other display device (or interface) (e.g., 4003). The renderer 3022 may interface with QuickTime® media player (e.g., the framework of QuickTime® media player) or another compatible application (or, framework) for audio/video decoding. In addition, the renderer 3022 may also interface with a composer-type application for actual rendering (e.g., of the slides), and the same or another similar application for applying filters 3006.

In some embodiments, the exporter 3023 may be considered the sharing module. The exporter 3023 may, for example, use renderer 3022 to export the slideshow/media presentation document to different formats (e.g., file formats) like those supported by QuickTime® or other similar application. The exporter 3023 may, for example, obtain movie frame-type data from renderer 3022 and add it to a movie-type file. When the exporter 3023 is finished retrieving data for each movie, the slideshow/media presentation document would be available for access and sharing through the exemplary application 1000 or other applications that may access or handle the document in its final format.

FIG. 4 illustrates an exemplary system implementing an application in accordance with the present invention. The exemplary system 4000, described above, may implement the exemplary application 1000. Other modules and other routine programming-related matters may not be shown in FIG. 4, but would be understood and may be implemented by one of ordinary skill in the art without departing from the scope of the present invention.

FIG. 5 illustrates an exemplary implementation of an application in accordance with the present invention. The module units 5001-5004 and 5010-5013 of the exemplary implementation of an application 5000 are described more fully above for FIG. 3A. The module units 5001-5004 and 5010-5013 may be implemented, for example, by a standalone 4008, 5008 or an embedded 4009, 5009 application, respectively. Further, an exemplary system such as that illustrated in FIG. 4 may execute the standalone 4008, 5008 or embedded 4009, 5009 applications. Other compatible or similar systems may also execute the applications 4008, 5008 and 4009, 5009 without departing from the scope of the present invention.

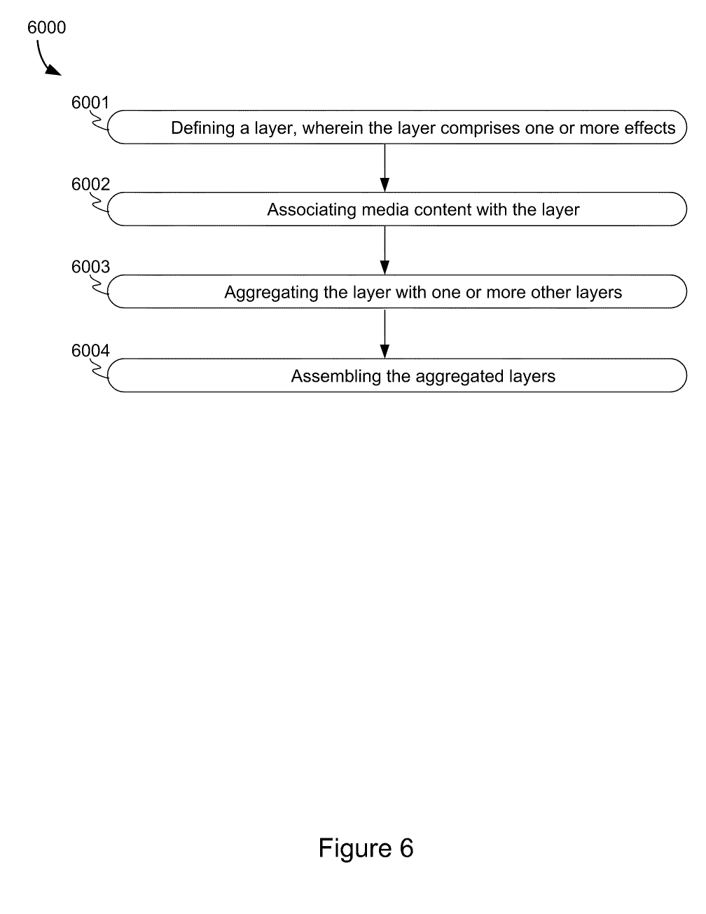

FIG. 6 illustrates an exemplary method in accordance with the present invention. The exemplary method 6000 comprises the following computer-implemented steps: defining a layer, wherein the layer comprises one or more effects 6001; associating media content with the layer 6002; aggregating the layer with one or more other layers 6003; and assembling the aggregated layer 6004. The exemplary method 6000 and, further, steps 6001-6004 may be implemented using an exemplary system such as that embodied in FIG. 4, which may execute the exemplary application 1000, and as described herein.

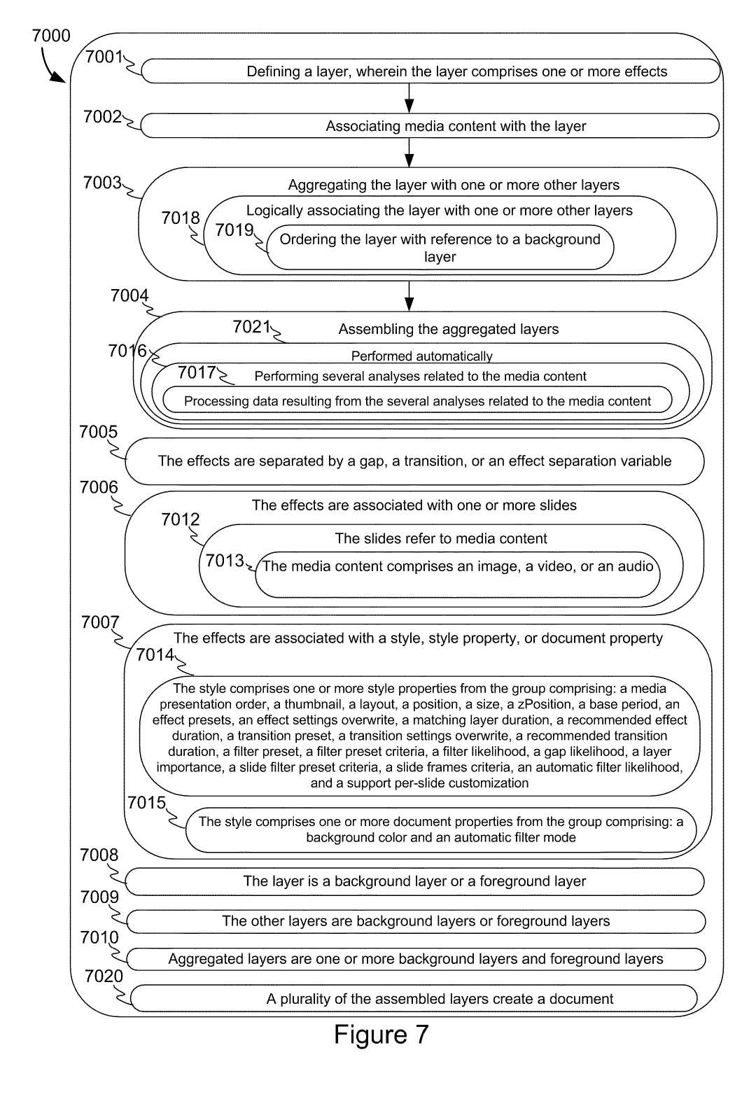

FIG. 7 illustrates an exemplary method in accordance with the present invention. The exemplary method 7000 comprises the computer-implemented steps of the exemplary method 6000 with the addition of steps 7005-7015. The exemplary method 7000 and, further, steps 7001-7015 may be implemented using an exemplary system such as that embodied in FIG. 4, which may execute the exemplary application 1000, and as described herein.

FIG. 8 illustrates an exemplary method in accordance with the present invention. The exemplary method 8000 may be implemented using an exemplary system such as that embodied in FIG. 4, which may execute the exemplary application 1000, and as described herein. At step 8001, styles are defined. The styles may have style properties. Styles and style properties may be defined by a user through application 1000 or may be predefined and stored on system 4000, such as in memory 4002 or local storage 4006. In some embodiments, producer 3021 in conjunction with core 3020 and renderer 3022 may also define styles.

In an exemplary embodiment, XML is used to define styles and style properties. It will be apparent to those skilled in the art that various other programming languages may be used to define the styles and style properties. Styles and style properties may be defined for a document 3001, layer 3002, effect container 3003, effect 3004, and/or slides 3005. In some embodiments, the styles are defined in a file. Each style may be defined in its own XML dictionary inside the file. A style manager may manage the styles and may have a hard-coded list of style name translations. The style manager may be a component of or in communication with producer 3021. Producer 3021 may track the available styles and associated style properties.

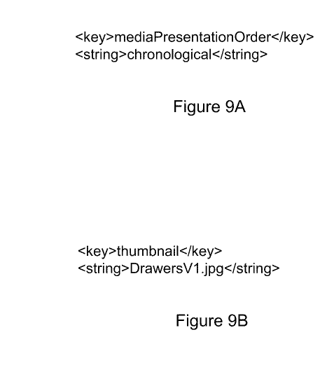

Examples of properties of a style that may be defined are illustrated in FIGS. 9A-9B, 10A-10T, and 11A-B. FIG. 9A is example of a property defining the media presentation order. In an exemplary embodiment, the supported values for the media presentation order property may include a chronological order, an order based on clusters, an order based on a person, an order based on a location, and an order based on a keyword. The default value for the media presentation order property may be ordering based on clusters.

In some embodiments, a style may provide its own thumbnail. FIG. 9B is an example of a property defining a thumbnail.

In some embodiments, the style definition includes a layout. The layout may be a dictionary of layer descriptions. A slideshow/media presentation may have one layer, such as the background layer, or may have multiple layers. Each layer may have a certain set of properties that will define its visual appearance. These properties may include background color, position and size (i.e., related to the actual output context), a list of supported effect presets, a list of supported transition presets, a list of supported filter presets, or a list of supported size frames. Other properties for defining a layer's visual appearance may be used.

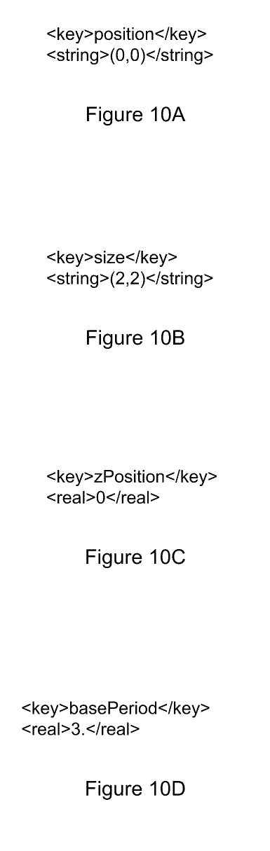

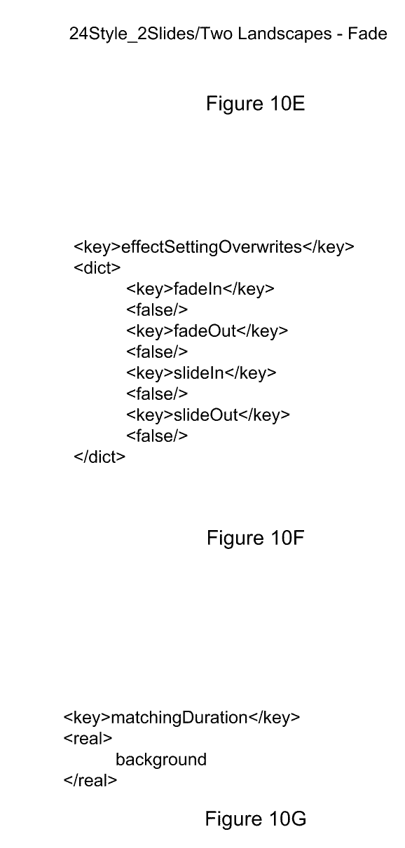

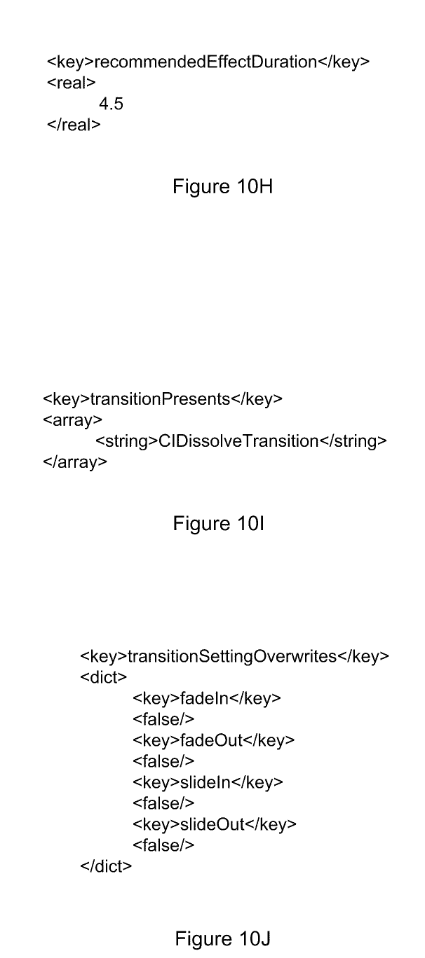

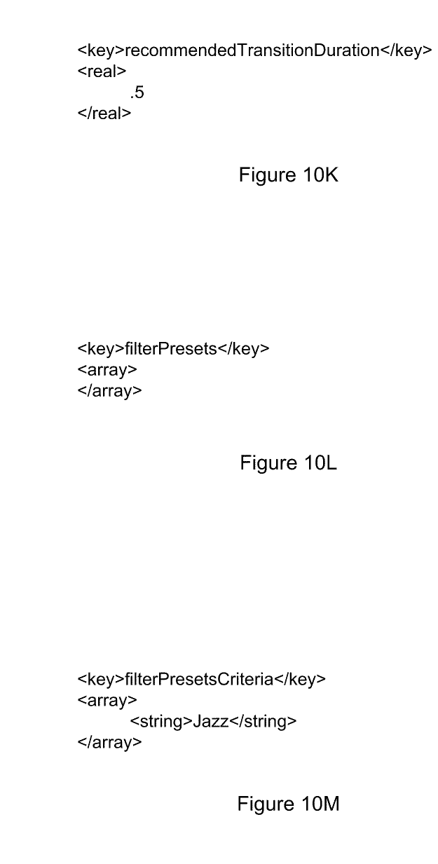

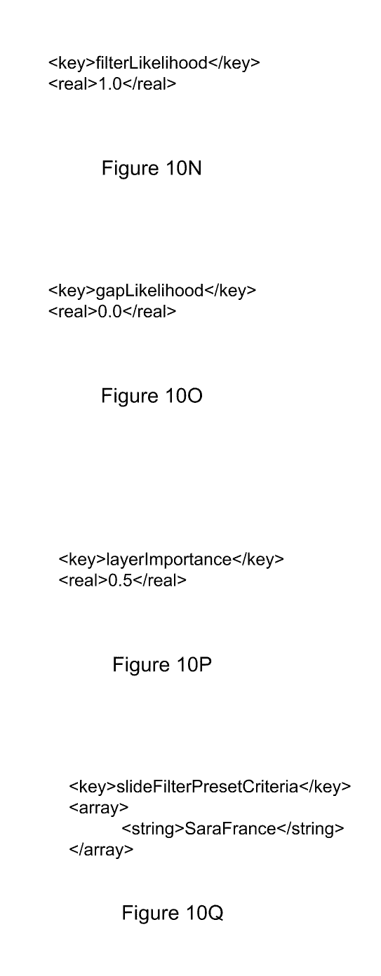

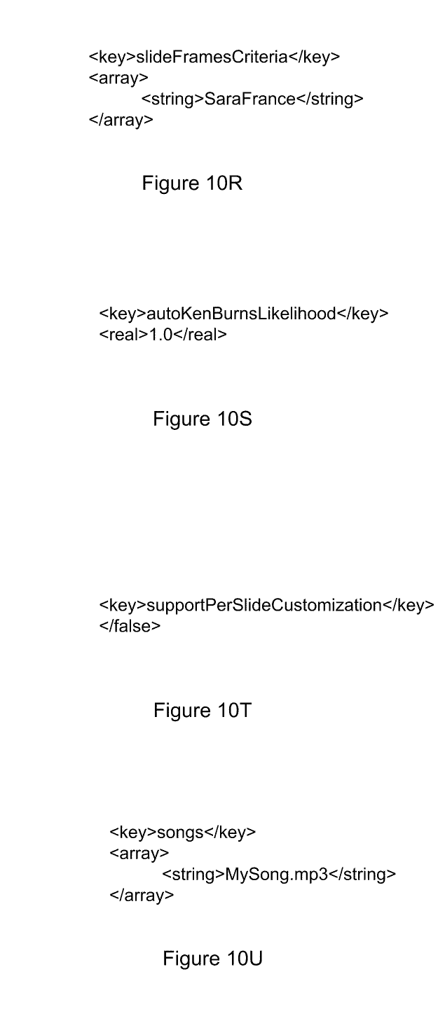

Several examples of layer properties will be illustrated. FIG. 10A illustrates an example of the position property. The position property may define the relative position of the layer with respect to the output context. In an exemplary embodiment, the supported values for the position property range from (0,0) to (2,2). The type of value may be a string with a format (X,Y), and the default layer position may be (0,0) (i.e., bottom left corner of the output context). FIG. 10B illustrates an example of the size property. The size property may define the relative size of the layer with respect to the output context. In an exemplary embodiment, the supported values range from (0,0) to (2,2). The type of value may be a string with a format (W,H). The default size may be (2,2), which means the layer will cover the whole output context. FIG. 10C illustrates an example of a z-position property. The z-position may define the z-order of layers. For example, the background layer of a slideshow/media presentation may have a z-position of “0.” Other optional layers may have higher z values. The optional layers may be stacked on top of the background layer when displayed. The default value may be “0,” and the type of value may be floating point number. FIG. 10D illustrates an example of the base period property. The base period property may define the scale of time for the layer. For example, a default base period of one may be defined. A style may change the base period to three. In this example, the playback on this layer will happen at three times real time. The type of value may be a floating point number.

FIG. 10E illustrates an example of effect presets property. In some embodiments, the effect presets are one of the core properties of a style. The effect presets may be an array of effect presets identifications (IDs). The effect presets IDs may instruct the producer 3021 in conjunction with the core 3020 and renderer 3022 (i.e., authoring environment) as to which effects are supported by the particular style defining the effect presets. An effect preset ID may contain a string combining an effect ID (e.g., 24Style_{—}2Slides) with a preset ID that is supported by the style (e.g., Two Landscapes-Fade). They may be combined by concatenating the two IDS with a “/.” The type of value may be an array of strings. A style may have as many effect presets as is necessary. If the preset ID is omitted, then all presets of the particular effect may be supported by the style and may be used by the producer 3021 in conjunction with the core 3020 and renderer 3022 (i.e., authoring environment).

In some embodiments, it may be convenient to select a list of pre-defined effect presets, and then in the style, overwrite some of the pre-defined effect presets settings in a global manner. Overwriting may prevent a user or producer 3021 from having to define new effect presets for all of the combinations needed in a style or styles. FIG. 10F illustrates an example of effect settings overwrites property. The type of values may be a dictionary of key/value pairs.

FIG. 10G illustrates an example of a matching layer duration property. The type of values may be a string. In some embodiments, a layer may have a key of another layer to match its duration. This may be useful for overlays. For example, if a user desired to have a filter layer on top of the background layer, the user would give the filter layer the key of the background layer.

FIG. 10H illustrates an example of a recommended effect duration property. In some embodiments, a style may recommend a default effect duration that may overwrite the default duration as it is defined in the effect description itself. The type of value may be a number, and the duration may be given in seconds. Producer 3021 may later overwrite the default effect duration in the style if necessary when automatically authoring or generating a slideshow/media presentation. For example, when a slideshow/media presentation is being generated based on the profiling of audio data (i.e., audio-driven layout stage) by producer 3021, the producer 3021 may overwrite the default effect duration in the style based on the audio data.

FIG. 10I illustrates an example of a transition presets property. This may be similar to the effects presets property illustrated in FIG. 10E. In some embodiments, the transition presets array may define a list of supported transitions using a similar transition ID/preset ID syntax as the effects presets property. The transition presets IDs may instruct the authoring environment as to which effects are supported by the particular style defining the effect presets. For example, the transition preset ID may contain a string combining a transition ID with a preset ID that is supported by the style. They may be combined by concatenating the two IDS with a “/.” The type of value may be an array of strings. A style may have as many transition presets as is necessary. If the preset ID is omitted, then all presets of the particular transition are supported by the style and may be used by the producer 3021 in conjunction with the core 3020 and renderer 3022 (i.e., authoring environment).

In some embodiments, it may be convenient to select a list of pre-defined transition presets, and then in the style, overwrite some of the pre-defined transition presets settings in a global manner. Overwriting may prevent a user or producer 3021 from having to define new transition presets for all of the combinations needed in a style or styles. FIG. 10J illustrates an example of transition settings overwrites property. The type of values may be a dictionary of key/value pairs.

FIG. 10K illustrates an example of a recommended transition duration property. In some embodiments, a style may recommend a default transition duration that may overwrite the default transition duration as it is defined in the transition description itself. The type of value may be a number, and the duration may be given in seconds. Producer 3021 may later overwrite the default transition duration in the style if necessary when automatically authoring or generating a slideshow/media presentation. For example, when a slideshow/media presentation is being generated based on the profiling of audio data (i.e., audio-driven layout stage) by producer 3021, the producer 3021 may overwrite the default transition duration in the style based on audio data.

FIG. 10L illustrates an example of a filter presets property. This may be similar to the effects presets property shown in FIG. 10E. In some embodiments, the filter presets array may define a list of supported effect-level filters using a similar filter ID/preset ID syntax as the effects presets property. The filters may be applied to all of the effects or an effect container. The filter presets IDs may instruct the producer 3021 in conjunction with the core 3020 and renderer 3022 (i.e., authoring environment) as to which filter are supported by the particular style defining the effect presets. The type of value may be an array of strings.

FIG. 10M illustrates an example of a filter preset criteria property. In some embodiments, a style may define a list of filter criteria to instruct the producer 3021 in conjunction with the core 3020 and renderer 3022 (i.e., authoring environment) as to which filters are appropriate to use in a slideshow/media presentation following the style. Filter preset criteria may be an alternative to defining a specific list of supported filters. The filter preset criteria may use tags to identify filters that are supported. For example, as shown in FIG. 10M, the Jazz style uses a Jazz-tag to identify which filters are supported by the style. The type of values may be an array of strings.

FIG. 10N illustrates an example of a filter likelihood property. In some embodiments, a style may instruct the producer 3021 as to how likely it is that a filter should be applied to an effect on the current layer. The likelihood may be a value between 0.0 and 1.0 with 0.0 meaning that no filter is applied and 1.0 meaning that every effect or effect container will have a filter applied to it. The type of values may be a floating point number.

FIG. 10O illustrates an example of a gap likelihood property. In some embodiments, a style may instruct the producer 3021 in conjunction with the core 3020 and renderer 3022 (i.e., the authoring environment) for each layer as to how likely it is that there will be a gap between effects on the current layer. The gap likelihood may be a value between 0.0 and 1.0 with 0.0 meaning that gaps are not acceptable for the layer and 1.0 meaning that the layer may be entirely composed of a gap. The type of values may be a floating point number.

FIG. 10P illustrates an example of a layer importance property. The type of values may be a floating point number. In some embodiments, a style may instruct the producer 3021 in conjunction with the core 3020 and renderer 3022 as to how important the particular layer is to the overall presentation. The most important layers may have a layer importance value of 1.0. All slides in this type of layer that were provided by the user need to be displayed at some point during the presentation of the layer. If a layer has an importance value of 0.5, then only half of the slides may be required to be shown at some point during the presentation. For example, every layer of a multi-layer presentation may not need to show all of the slides provided by the user during the media presentation/slideshow. Instead, a secondary layer may only show a few slides periodically. In another example, the style may define if the background layer is the main layer or if it is a sub-layer (i.e., more of an ambient layer) based on how important the layer is to the overall media presentation/slide show.

FIG. 10Q illustrates an example of a slide filter preset criteria property. In some embodiments, a style may define a filter for an effect as well as define a list of filters that will be applied only to individual slides. The slide filter preset criteria may be used for this purpose. The type of values may include an array of strings.

FIG. 10R illustrates an example of a slide frames criteria property. A style may support the automatic framing of slides. For example, a criteria-based approach may instruct the producer 3021 in conjunction with the core 3020 and renderer 3022 (i.e., authoring environment) as to what slide frames are supported and what slide frames are not supported based on criteria.

FIG. 10S illustrates an example of an automatic Ken Burns-effect (i.e., pan and zoom animation) likelihood property. The type of values may include floating point number. In some embodiments, a style may instruct the producer 3021 in conjunction with the core 3020 and renderer 3022 (i.e., authoring environment) for each layer, how likely it that an automatic Ken Burns-effect should be applied to each slide in each effect on the current layer. The likelihood may be a value between 0.0 and 1.0 with 0.0 meaning that no filter is applied and 1.0 meaning that every effect or effect container will have a filter applied to it.

FIG. 10T illustrates an example of a support per slide customization property. In some embodiments, a style may instruct the producer 3021 in conjunction with the core 3020 and renderer 3022 (i.e., authoring environment) for each layer, whether producer 3021 may customize settings on a per-slide level or whether producer 3021 is to preserve whatever the effect presets supported by the style recommend. The type of values may be boolean logic.

FIG. 10U illustrates an example of a song property. A style may define a default background audio track. The audio track files may be included in a folder of the style and may give the style and array of file names. The type of value may include an array of strings.

In some embodiments, the properties or settings defined at the top level of an XML style description are considered document level properties. These document-level properties may be applied to the document 3001 itself. The same property that is set for a document 3001 may also be set at different levels, such as the layer 3002 level, effect container 3003 level, the effect 3004 level, or the slide 3005 level. For example, the background color property may be set on the effect container 3003 level and may also be set at the document 3001 level. The document 3001 level background color may be overwritten by the effect container 3003 level background color if the effect container 3003 has an explicitly defined background color.

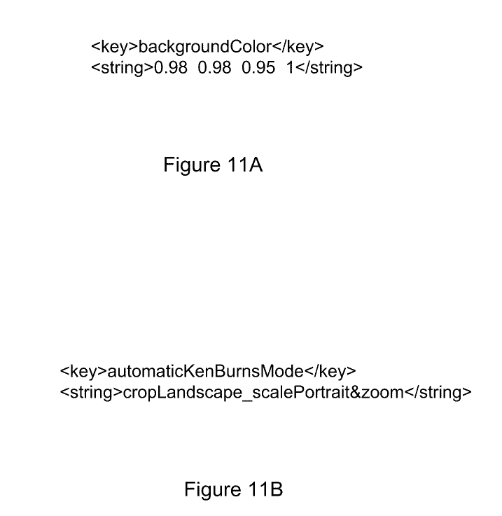

Examples of document level properties are shown in FIGS. 11A and 11B. FIG. 11A illustrates an example of a background color property. In some embodiments, a style may define a document level background color. The background color may be applied to every effect in a slideshow/media presentation. However, the background color may be overwritten by effect 3004 level background colors. The type of values may be a string.

FIG. 11B illustrates an example of an automatic Ken Bums mode property. In some embodiments, a Ken Bums-effect may be applied to a slide in a several different ways. For example, the Ken-Burns effect may be a crop and zoom, a scale and zoom, or a hybrid mix. The crop and zoom may crop images so that the slide fits on the entire screen and then animate a pan and zoom over the slide. The scale and zoom may scale down the slide to fit entirely on the screen and then perform a pan and zoom over the slide. The two basic modes may be mixed. For example, the Ken Bums-effect may crop and zoom landscape images and scale and zoom portrait-format images by default. A user may change the default to crop and zoom or scale and zoom at all times by selecting a checkbox displayed in application 1000. A style may define the Ken Burns-effect on the document 3001 level. This may allow a user or producer 3021 to define the Ken-Burns effect globally. However, this effect may be overwritten on the effect container 3003 level or slide 3005 level. The type of values may be strings.

At step 8002, the style is applied to the layer 3002. The layer may comprise one or more effects 3004. Producer 3021 may apply the style to the layer or effects 3004. In some embodiments, producer 3021 may customize settings of the layer 3002 or effects 3004 when the style is applied. In addition, for example, when the position property is defined in a style, producer 3021 may customize the position setting of the layer based on the position in the style. In addition, producer 3021 may customize the effect background color setting based on the effect background color property defined in a style. In some embodiments, producer 3021 may overwrite the default values of the layer 3002 or the effects 3004 when applying a style. For example, producer 3021 may overwrite predefined effect presets in a global manner based on the effect settings overwrite property. When the styles are applied to the layers and effects, the resulting layer or effect may be displayed in application 1000 along with the applied style, such as the add effects container region 1003 or 2000.

At step 8003, a media presentation is automatically generated using the applied style and the layer. Producer 3021 may assemble the layers and effects in a slide show/media presentation using the styles and style properties that were applied to the layers and effects. Producer 3021 may overwrite the applied style associated with a layer or effect. For example, when a slideshow/media presentation is being generated based on the profiling of audio data (i.e., audio-driven layout stage) by producer 3021, the producer 3021 may overwrite the effect default transition duration property in the style and applied to the effect based on audio data.

FIG. 12 illustrates an exemplary method in accordance with the present invention. The exemplary method 1200 comprises the computer-implemented step of the exemplary method 8000 with the addition of steps 1202-1203. The exemplary method 8000 and, further, steps 1201-1203 may be implemented using an exemplary system such as that embodied in FIG. 4, which may execute the exemplary application 1000, and as described herein.

At step 1202, the style is applied to a document 3001 and at least one of a layer 3002, an effect container 3003, an effect 3004, a slide 3005, or other objects in FIG. 3. Producer 3021 may apply the style to the document 3001 and the layer 3002, the effect container 3003, the effect 3004, the slide 3005, or the other objects in FIG. 3. In some embodiments, producer 3021 may customize settings of the document 3001 and the layer 3002, the effect container 3003, the effect 3004, the slide 3005, or the other objects in FIG. 3 when the style is applied as described above with respect to step 8002. In some embodiments, producer 3021 may overwrite the default values of the document 3001 and the layer 3002, the effect container 3003, the effect 3004, the slide 3005, or the other objects in FIG. 3 when applying a style as described above with respect to step 8002. When the styles are applied to the document 3001 and the layer 3002, the effect container 3003, the effect 3004, the slide 3005, or the other objects in FIG. 3, the resulting objects may displayed in application 1000 along with the applied style, such as the add effects container region 1003 or 2000.

At step 1203, a media presentation is automatically generated using the applied style and the document 3001 and the layer 3002, the effect container 3003, the effect 3004, the slide 3005, or the other objects in FIG. 3. For example, producer 3021 may assemble the document 3001 and the layer 3002, the effect container 3003, the effect 3004, the slide 3005, or the other objects in FIG. 3 in a slide show/ media presentation using the styles and style properties that were applied to the document 3001 and the layer 3002, the effect container 3003, the effect 3004, the slide 3005, or the other objects in FIG. 3. Producer 3021 may overwrite the applied style associated the document 3001 and the layer 3002, the effect container 3003, the effect 3004, the slide 3005, or the other objects in FIG. 3 as described above with respect to step 8003.

Furthermore, producer 3021 may overwrite applied styles based on a hierarchy. For example, a document level property is applied to the document itself. The same property may be set at different levels, such as the layer 3002 level, effect container 3003 level, the effect 3004 level, or the slide 3005 level. Producer 3021 may overwrite the document 3001 level property with the effect container 3003 level property if the effect container 3003 has the same explicitly defined property.

In some embodiments, document level properties may be overwritten by layer level properties, effect container level properties, effect level properties, and slide level properties. Layer level properties may be overwritten by effect container level properties, effect level properties, and slide level properties. Effect container level properties may be overwritten by effect level properties and slide level properties. Effect level properties may be overwritten by slide level properties.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

We claim:

1. A computer-implemented method for authoring media presentations, comprising:
defining a style, the style comprising one or more style properties;
applying the style to a layer, the layer comprising one or more effects; and
automatically generating a media presentation using the applied style and the layer.

2. The computer-implemented method of claim 1, wherein the one or more style properties are selected from the group comprising: a media presentation order, a thumbnail, a layout, a position, a size, a zPosition, a base period, an effect presets, an effect settings overwrite, a matching layer duration, a recommended effect duration, a transition preset, a transition settings overwrite, a recommended transition duration, a filter preset, a filter preset criteria, a filter likelihood, a gap likelihood, a layer importance, a slide filter preset criteria, a slide frames criteria, an automatic filter likelihood, and a support per-slide customization.

3. The computer-implemented method of claim 1, wherein the step of applying further comprises customizing one or more settings of the one or more effects.

4. The computer-implemented method of claim 1, wherein the step of applying further comprises overriding a default value of the one or more effects.

5. The computer-implemented method of claim 1, wherein the step of automatically creating further comprises overwriting the applied style.

6. The computer-implemented method of claim 5, wherein the overwriting is based on an analysis of audio data.

7. A computer-implemented method for authoring media presentations, comprising:
defining a style, the style comprising one or more style properties;
applying the style to a document and at least one of a layer, an effect container, an effect and a slide; and
automatically generating a media presentation using the applied style, the document, and the at least one layer, effect container, effect, and slide.

8. The computer-implemented method of claim 7, wherein the one or more style properties are selected from the group comprising: a media presentation order, a thumbnail, a layout, a position, a size, a z-position, a base period, an effect presets, an effect settings overwrite, a matching layer duration, a recommended effect duration, a transition preset, a transition settings overwrite, a recommended transition duration, a filter preset, a filter preset criteria, a filter likelihood, a gap likelihood, a layer importance, a slide filter preset criteria, a slide frames criteria, an automatic filter likelihood, and a support per-slide customization.

9. The computer-implemented method of claim 7, wherein the step of applying further comprises customizing one or more settings of the document or the at least one layer, effect container, effect, and slide.

10. The computer-implemented method of claim 7, wherein the step of applying further comprises overriding a default value of the document or the at least one layer, effect container, effect, and slide.

11. The computer-implemented method of claim 7, wherein the step of automatically creating further comprises overwriting the applied style.

12. The computer-implemented method of claim 11, wherein the overwriting is based on an analysis of audio data.

13. The computer-implemented method of claim 7, wherein the overwriting further comprises overwriting the applied style of the document with the applied style of the at least one layer, effect container, effect, and slide.

14. A system for authoring media presentations, comprising
memory to store a style, the style comprising one or more style properties; and
one or more processors configured to define the style, apply the style to a layer, and automatically generate a media presentation using the applied style and the layer, the layer comprising one or more effects.

15. The system of claim 14, wherein the one or more style properties are selected from the group comprising: a media presentation order, a thumbnail, a layout, a position, a size, a zPosition, a base period, an effect presets, an effect settings overwrite, a matching layer duration, a recommended effect duration, a transition preset, a transition settings overwrite, a recommended transition duration, a filter preset, a filter preset criteria, a filter likelihood, a gap likelihood, a layer importance, a slide filter preset criteria, a slide frames criteria, an automatic filter likelihood, and a support per-slide customization.

16. The system of claim 14, wherein the processor is further configured to customize one or more settings of the one or more effects.

17. The system of claim 14, wherein the processor is further configured to override a default value of the one or more effects.

18. The system of claim 14, wherein the processor is further configured to overwrite the applied style.

19. The system of claim 18, wherein the processor is further configured to overwrite based on an analysis of audio data.

20. A system for authoring media presentations, comprising:
memory to store a style, the style comprising one or more style properties; and
one or more processors configured to define the style, apply the style to a document and at least one of a layer, an effect container, an effect and a slide, and automatically generating a media presentation using the applied style, the document, and the at least one layer, effect container, effect, and slide.

21. The system of claim 20, wherein the one or more style properties are selected from the group comprising: a media presentation order, a thumbnail, a layout, a position, a size, a z-position, a base period, an effect presets, an effect settings overwrite, a matching layer duration, a recommended effect duration, a transition preset, a transition settings overwrite, a recommended transition duration, a filter preset, a filter preset criteria, a filter likelihood, a gap likelihood, a layer importance, a slide filter preset criteria, a slide frames criteria, an automatic filter likelihood, and a support per-slide customization.

22. The system of claim 20, wherein processor is further configured to customize one or more settings of the document or the at least one layer, effect container, effect, and slide.

23. The system of claim 20, wherein processor is further configured to override a default value of the document or the at least one layer, effect container, effect, and slide.

24. The system of claim 20, wherein the processor is further configured to overwrite the applied style.

25. The system of claim 24, wherein the processor is further configured to overwrite based on an analysis of audio data.

26. The system of claim 24, wherein the processor is further configure to overwriting the applied style of the document with the applied style of the at least one layer, effect container, effect, and slide.

27. A computer-readable storage medium storing one or more programs configured for execution by a computer, the one or more programs comprising instructions to:
define a style, the style comprising one or more style properties;
apply the style to a layer, the layer comprising one or more effects; and
automatically generate a media presentation using the applied style and the layer.

28. A computer-readable storage medium storing one or more programs configured for execution by a computer, the one or more programs comprising instructions to:
define a style, the style comprising one or more style properties;
apply the style to a document and at least one of a layer, an effect container, an effect and a slide; and
automatically generate a media presentation using the applied style, the document, and the at least one layer, effect container, effect, and slide.
